(19) United States
(12) Patent Application Publication
(10) Pub. No.: US 2007/0034491 A1
(43) Pub. Date: Feb. 15, 2007

(54) Housing and and a conducting rail for disconnecting a battery

(76) Inventors: Juergen Knauss, Obermichelbach (DE); Uwe Brede, Fuerth (DE); Gerhard Kordel, Nuernberg-Kornburg (DE); Juergen Neuser, Massenbachhausen (DE); Wolfgang Seitz, Leingarten (DE); Paulus Bayer, Nassenfeld/Zell (DE); Georg Seitz, Kasing (DE)

Correspondence Address: DELPHI TECHNOLOGIES, INC., M/C 480-410-202, PO BOX 5052, TROY, MI, 48007, US

(21) Appl. No.: 10/548,761

(22) PCT Filed: Mar. 2, 2004
(86) PCT No.: PCT/EP04/02113

§ 371 Date: May 2, 2006

(30) Foreign Application Priority Data
Mar. 12, 2003 (DE) 103 11 195.6

(51) Int. Cl. H01H 85/00

(52) U.S. Cl. 200/61.08

(57) ABSTRACT

The invention relates to a device for pyromechanical separation comprising a housing (4) and a conducting rail (2) which is arranged therein and embodied in such a way that it is separable at a separation point (13) by a separating tool (6) which is actuated by a propulsion pyrotechnical charge (12). In order to protect said conducting rail against manipulations and ensure an unequivocal positioning, the conducting rail (2), the propulsion charge (12) and the separating tool (6) are fixed in the housing (4) in an irremovable manner by a latch (5) which is inserted into the housing (4) and are nondetachably fixed thereto. Said latch (5) is also used as a support for the separating tool (6), i.e. it comprises a cutting edge (7) along which said separating tool (7) cuts.

The invention relates to a pyromechanical separating device having a housing, in which an electrical conductor rail is arranged, which is designed to be separable by a separating tool driven by a pyrotechnic propellant charge.

Such a pyromechanical separating device is described in German Offenlegungsschrift 19 712 387 and shows an electrical conductor rail, which is arranged in a housing with a pyrotechnic propellant charge and a separating tool.

The disadvantage of this generic separating device is that the pyrotechnic propellant charge may be dismantled from the housing without destruction and the separating device is not protected against manipulations of this type. Furthermore, unambiguous positioning of the conductor rail is not provided, so that an absolutely safe separating process is not ensured.

According to the invention, these disadvantages are rectified in that the conductor rail, the propellant charge and the separating tool are anchored to be non-detachable in the housing by a latch inserted into the housing and connected non-releasably to the latter and the latch at the same time represents the counter-bearing for the separating tool, that is, in that the latch has a cutting edge, along which the separating tool cuts.

The separating device is thus protected against manipulations and in addition an absolutely safe separating process is guaranteed.

In an advantageous embodiment, a recess, which is pushed onto a matching guide rib on the housing, is arranged on the conductor rail.

Chamfers are preferably arranged on the latch above and below the cutting edge, as a result of which the latch and the housing and hence the conductor rail and the separating tool are centred themselves during assembly and safe shearing-off of the conductor is guaranteed.

In an advantageous embodiment, the latch is firmly connected to the housing by welding or a non-releasable snap-in connection.

The latch is preferably clamped in the housing additionally via a tongue and groove connection.

The separating device according of the invention is advantageously used for the electrical uncoupling of a car battery in the event of an accident.

The figures, which are described below, show further features of the invention.

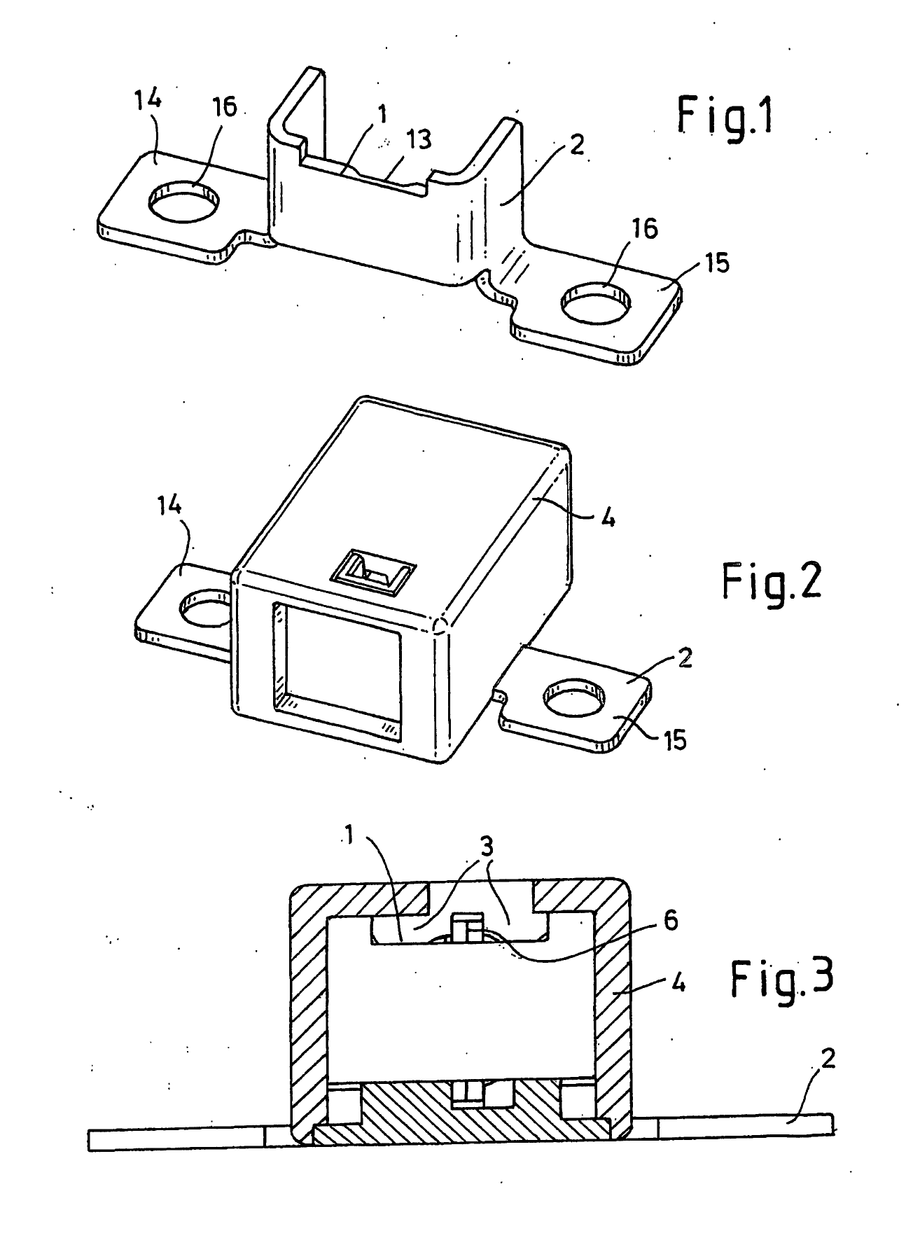

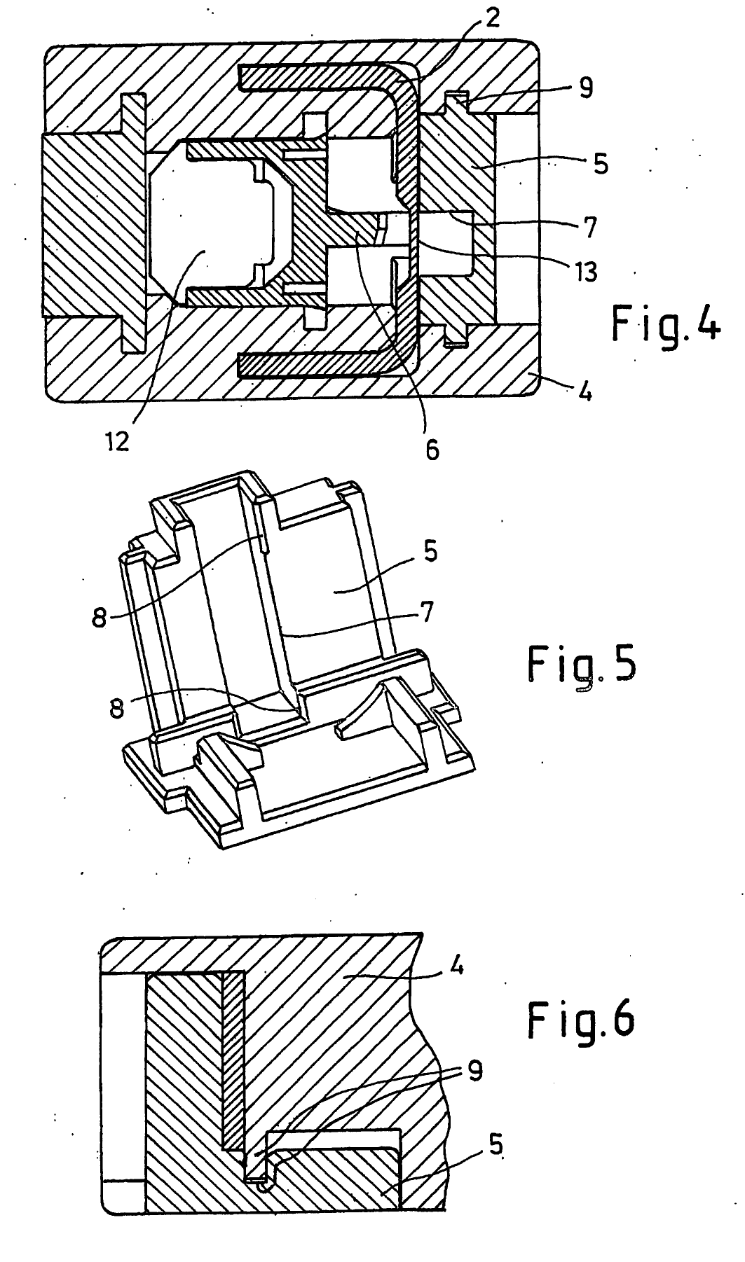

FIG. 1 shows a conductor rail 2 having a separating point 13, which is designed to be separable by a separating tool 6 (see FIG. 3 or 4). This conductor rail 2 is installed in a housing 4 (see FIG. 2). So that the conductor rail 2 cannot be laterally displaced in the housing 4, a recess 1 (see FIG. 1) is arranged on the conductor rail 2, and is pushed onto a matching guide rib 3 (see FIG. 3) on the housing 4.

The conductor rail is designed like a hoop and has at its ends 14, 15 in each case a bore 16 for attachment of the conductor rail 2, for example on the one hand to a car battery and on the other hand to current-conducting cable of a motor vehicle.

A latch 5 (see FIGS. 4 and 5) inserted laterally into the housing 4 clamps the conductor rail 2 in the housing 4, so that an axial movement of the conductor rail 2 is impossible in the acceleration direction of the separating tool 6. The latch 5 thus forms the counter-bearing for the separating tool 6, that is, the latch 5 contains a cutting edge 7, along which the separating tool 6 may cut.

Chamfers 8 on the counter-bearing or on the latch 5 above and below the cutting edge 7 ensure that the separating tool 6 centres itself and does not impact on the full material of the counter-bearing or of the latch 5.

The conductor rail 2 is additionally firmly clamped to the housing 4 by a tongue-groove connection 9 (see FIG. 6) on the latch 5 or housing 4.

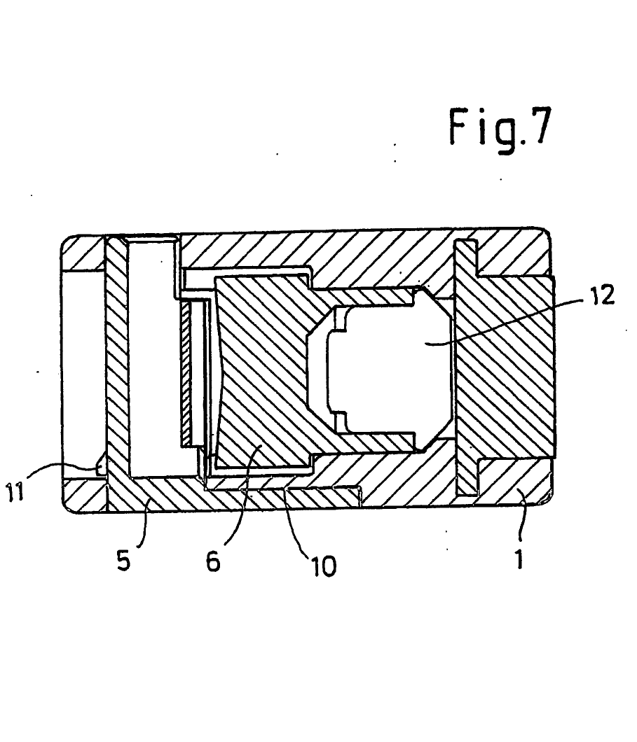

To protect against manipulations, the inserted latch 5 is firmly connected to the housing 4 by welding 10 or a non-releasable snap-in connection 11 (see FIG. 7). The igniter or the propellant charge 12 (FIG. 7) may be detached only with intentional destruction of the housing 4. In addition, this firm connection between latch 5 and housing 4—welding or non-releasable snap-in connection—ensures that the housing 4 is not released from the conductor rail 2, for example during dynamic load.

This pyromechanical separating device is preferably used for the electrical uncoupling of a car battery in the event of an accident. This separating device is therefore also designated as battery disconnection.

1. Pyromechanical separating device having a housing (4), in which an electrical conductor rail (2) is arranged, which is designed to be separable at a separating point (13) by a separating tool (6) driven by a pyrotechnic propellant charge (12), characterised in that the conductor rail (2), the propellant charge (12) and the separating tool (6) are anchored to be non-detachable in the housing (4) by a latch (5) inserted into the housing (4) and connected non-releasably to the latter and the latch (5) at the same time represents the counter-bearing for the separating tool (6), that is, in that the latch (5) has a cutting edge (7), along which the separating tool (6) cuts.

2. Separating device according to claim 1, characterised in that a recess (1), which is pushed onto a matching guide rib (3) on the housing (4), is arranged on the conductor rail (2).

3. Separating device according to claim 1 or 2, characterised in that chamfers (8) are arranged on the latch (5) above and below the cutting edge (7).

4. Separating device according to one of claims 1 to 3, characterised in that the latch (5) is firmly connected to the housing (4) by welding (10) or a non-releasable snap-in connection (11).

5. Separating device according to claim 4, characterised in that the latch (5) is clamped in the housing (4) additionally via a tongue and groove connection (9).

6. Use of the pyromechanical separating device according to one of claims 1 to 5 for the electrical uncoupling of a car battery in the event of an accident.
